(19) United States
(12) Patent Application Publication
(10) Pub. No.: US 2013/0116357 A1
(43) Pub. Date: May 9, 2013

(54) POLYURETHANE HAVING LOW VOLUME SHRINKAGE

(71) Applicants: Hans-Josef Laas, Odenthal (DE); Dorota Greszta-Franz, Solingen (DE); Reinhard Halpaap, Odenthal (DE); Dieter Mager, Leverkusen (DE); Hans-Ulrich Meier-Westhues, Leverkusen (DE)

(72) Inventors: Hans-Josef Laas, Odenthal (DE); Dorota Greszta-Franz, Solingen (DE); Reinhard Halpaap, Odenthal (DE); Dieter Mager, Leverkusen (DE); Hans-Ulrich Meier-Westhues, Leverkusen (DE)

(73) Assignee: BAYER INTELLECTUAL PROPERTY GMBH, Monheim (DE)

(21) Appl. No.: 13/811,051

(22) PCT Filed: Jul. 15, 2011
(86) PCT No.: PCT/EP2011/062176

§ 371 Date: Jan. 18, 2013

(30) Foreign Application Priority Data
Jul. 20, 2010 (DE) 10 2010 031 681.4

(51) Int. Cl. C08G 18/28

(52) U.S. Cl. CPC C08G 18/28
USPC 521/172; 528/85; 524/871; 528/80

(57) ABSTRACT

The invention relates to the use of solvent-free modified polyisocyanate mixtures on the basis of araliphatic diisocyanates for producing light- and weather-resistant polyurethane bodies having light refraction and low dispersion.

The preparation of light-fast and weather-resistant plastics by reaction of aliphatic or cycloaliphatic polyisocyanates with compounds which contain acid hydrogen atoms is known. Depending on the nature of the H-acid reaction partners, such as e.g. polyols, polyamines and/or polythiols, polyaddition products with, for example, urethane, urea and/or thiourethane structures are formed here.

The general term “polyurethanes” is also used in the following as a synonym for the large number of different polymers which can be prepared from polyisocyanates and H-acid compounds.

For various uses, for example as a lightweight substitute for mineral glass for the production of panes for automobile and aircraft construction or as embedding compositions for optical, electronic or optoelectronic components, an increasing interest in transparent, light-fast polyurethane compositions is currently to be recorded in the market.

For high performance optical uses in particular, such as e.g. for lenses or spectacle lenses, there is generally the desire for plastics materials which have a high refraction of light and at the same time a low dispersion (high Abbe number).

The preparation of transparent polyurethane compositions with a high refractive index has already been frequently described. As a rule, so-called araliphatic diisocyanates, i.e. those diisocyanates in which the isocyanate groups are present bonded to an aromatic system via aliphatic radicals, are employed as the polyisocyanate component in this context. Due to their aromatic structures, araliphatic diisocyanates give polyurethanes which have an increased refractive index, and at the same time the aliphatically bonded isocyanate groups guarantee the light fastness and low tendency towards yellowing which are required for high performance uses.

U.S. Pat. No. 4,680,369 and U.S. Pat. No. 4,689,387 describe, for example, polyurethanes and polythiourethanes which are suitable as lens materials, in the preparation of which specific sulfur-containing polyols or mercapto-functional aliphatic compounds are combined with monomeric araliphatic diisocyanates, such as e.g. 1,3-bis(isocyanatomethyl)benzene (m-xylylene-diisocyanate, m-XDI), 1,4-bis(isocyanatomethyl)benzene (p-xylylene-diisocyanate, p-XDI), 1,3-bis(2-isocyanatopropan-2-yl)benzene (m-tetramethylxylylene-diisocyanate, m-TMXDI) or 1,3-bis(isocyanatomethyl)-2,4,5,6-tetrachlorobenzene, to achieve particularly high refractive indices.

Monomeric araliphatic diisocyanates, such as m- and p-XDI or m-TMXDI, are also mentioned as the preferred polyisocyanate composition for the preparation of high-refraction lens materials in a large number of further publications, such as e.g. EP-A 0 235 743, EP-A 0 268 896, EP-A 0 271 839, EP-A 0 408 459, EP-A 0 506 315, EP-A 0 586 091 and EP-A 0 803 743. In this context they serve as crosslinker components for polyols and/or polythiols and, depending on the reaction partner, give transparent plastics with high refractive indices in the range of from 1.56 to 1.67 and comparatively high Abbe numbers of up to 45.

An essential disadvantage of the processes mentioned for the preparation of highly light-refracting polyurethanes for optical uses is, however, that during their curing a sometimes considerable volume shrinkage occurs, which can raise problems in particular during casting of structural elements, for example in the production of optical lenses of defined geometry.

The object of the present invention was therefore to provide novel polyurethane compositions which react with significantly less volume contraction to give highly transparent, light- and weather-resistant shaped articles with a high refraction of light and low dispersion and are thus also suitable in particular for production of optical precision parts.

It has been possible to achieve this object by providing the polyurethanes described in more detail below.

The invention described in more detail below is based on the surprising observation that solvent-free polyisocyanate mixtures comprising a proportion of modified, for example a proportion of trimerized or biuretized, araliphatic diisocyanates can be processed under conventional conditions with reaction partners which are reactive towards isocyanate groups to give light-fast, non-yellowing polyurethane bodies which cure with significantly less volume shrinkage than the polyurethanes know hitherto based on exclusively monomeric araliphatic diisocyanates, and moreover are also distinguished by a still further increased refraction of light and at the same time improved mechanical properties.

The present invention provides the use of solvent-free polyisocyanate components A) which comprise, to the extent of 5 to 95 wt. %, polyisocyanate molecules built up from at least two araliphatic diisocyanate molecules and, to the extent of 95 to 5 wt. %, monomeric araliphatic diisocyanates and have a content of isocyanate groups of from 18 to 43 wt. % for the production of light-fast compact or foamed polyurethane bodies.

The invention also provides a process for the preparation of light-fast polyurethane compositions by solvent-free reaction of
A) polyisocyanate mixtures which comprise, to the extent of 5 to 95 wt. %, polyisocyanates built up from at least two araliphatic diisocyanate molecules and, to the extent of 95 to 5 wt. %, monomeric araliphatic diisocyanates and have a content of isocyanate groups of from 18 to 43 wt. %,
   with
B) reaction partners which are reactive towards isocyanate groups and have an average functionality of from 2.0 to 6.0, and optionally co-using
C) further auxiliary substances and additives,
   maintaining an equivalent ratio of isocyanate groups to groups which are reactive towards isocyanates of from 0.5:1 to 2.0:1.

Finally, the invention also provides the transparent compact or foamed shaped articles produced from the light-fast polyurethane compositions obtainable in this way.

Component A) employed in the process according to the invention comprises solvent-free polyisocyanate mixtures which are accessible by modification of a proportion of araliphatic diisocyanates and which comprise, to the extent of 5 to 95 wt. %, polyisocyanate molecules built up from at least two araliphatic diisocyanate molecules and, to the extent of 95 to 5 wt. %, monomeric araliphatic diisocyanates and have a content of isocyanate groups of from 18 to 43 wt. %,

Suitable araliphatic diisocyanates for the preparation of polyisocyanate components A) are any desired diisocyanates which are accessible by phosgenation or by phosgene-free processes, for example by urethane cleavage by means of heat, the isocyanate groups of which are present bonded to an optionally further substituted aromatic via optionally branched aliphatic radicals, such as e.g. 1,3-bis(isocyanatomethyl)benzene (m-xylylene-diisocyanate, m-XDI), 1,4-bis(isocyanatemethyl)benzene (p-xylylene-diisocyanate, p-XDI), 1,3-bis(2-isocyanatopropan-2-yl)benzene (m-tetramethylxylylene-diisocyanate, m-TMXDI), 1,4-bis(2-isocyanatopropan-2-yl)benzene (p-tetramethylxylylene-diisocyanate, p-TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(isocyanatomethyl)-4,5-dimethylbenzene, 1,4-bis (isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatemethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene, 1,4-bis(isocyanatomethyl)naphthalene and any desired mixtures of these diisocyanates.

The preparation of the polyisocyanate components A) from the araliphatic diisocyanates mentioned is carried out with the aid of modification reactions known per se, by reaction of some of the isocyanate groups originally present in the starting diisocyanate to form polyisocyanate molecules which comprise at least two diisocyanate molecules, and is not subject matter of the present application.

Suitable such modification reactions are, for example, the conventional processes for catalytic oligomerization of isocyanates to form uretdione, isocyanurate, iminooxadiazinedione and/or oxadiazinetrione structure or for biuretization of diisocyanates, such as are described by way of example e.g. in Laas et al., J. Prakt. Chem. 336, 1994, 185-200, in DE-A 1 670 666 and EP-A 0 798 299. Concrete descriptions of such polyisocyanates based on araliphatic diisocyanates are also to be found e.g. in EP-A 0 081 713, EP-A 0 197 543, GB-A 1 034 152 and JP-A 05286978.

Suitable modification reactions for the preparation of the polyisocyanate components A) are, however, also urethanization and/or allophanation of araliphatic diisocyanates after addition of less than molar amounts of hydroxy-functional reaction partners, in particular low molecular weight mono- or polyfunctional alcohols of the molecular weight range of 32 to 300, such as e.g. methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxylmethylcyclohexane, 3-methyl-3-hydroxymethyloxetane, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)-biscyclohexanol, di-ethylene glycol, dipropylene glycol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)isocyanurate, or any desired mixtures of such alcohols. Preferred alcohols for the preparation of urethane- and/or allophanate-modified polyisocyanate components A) are the monoalcohols and diols mentioned having 2 to 8 carbon atoms.

Concrete descriptions of urethane- and/or allophanate-modified polyisocyanates based on araliphatic diisocyanates are to be found, for example, in EP-A 1 437 371, EP-A 1 443 067, JP-A 200516161691, JP-A 2005162271.

Depending on the nature of the araliphatic diisocyanates employed and the modification reaction chosen, in the preparation of the polyisocyanate components A) employed according to the invention, in contrast to that which is conventional, for example, in the preparation of lacquer polyisocyanates and is described in the patent literature cited above, separating off of the unreacted monomeric diisocyanate excess after the modification has been carried out is omitted. Clear, practically colourless polyisocyanate mixtures which are based on araliphatic diisocyanates and contain uretdione, isocyanurate, iminooxadiazinedione, urethane, allophanate, biuret and/or oxadiazinetrione groups and which comprise, preferably to the extent of 20 to 80 wt. %, particularly preferably to the extent of 35 to 65 wt. %, polyisocyanate molecules which are built up from at least two araliphatic diisocyanate molecules and, preferably to the extent of 80 to 20 wt. %, particularly preferably to the extent of 65 to 35 wt. %, monomeric araliphatic diisocyanates and which preferably have a content of isocyanate groups of from 20 to 40 wt. %, particularly preferably from 23 to 36 wt. %, are obtained in this manner.

Very particularly preferred polyisocyanate components A) are those of the type described above based on m-XDI, p-XDI and/or m-TMXDI with a content of isocyanate groups of from 24 to 35 wt. %, in particular those which contain uretdione, isocyanurate, iminooxadiazinedione, allophanate and/or biuret groups.

For the preparation of the light-fast polyurethane compositions according to the invention, the polyisocyanates A) described above are reacted with any desired solvent-free reaction partners B) which are reactive towards isocyanate groups and have an average functionality in the sense of the isocyanate addition reaction of from 2.0 to 6.0, preferably from 2.5 to 4.0, particularly preferably from 2.5 to 3.5.

These are, in particular, the conventional polyether polyols, polyester polyols, polyether-polyester polyols, polythioether polyols, polymer-modified polyether polyols, graft polyether polyols, in particular those based on styrene and/or acrylonitrile, polyether-polyamines, polyacetals containing hydroxyl groups and/or aliphatic polycarbonates containing hydroxyl groups which are known from polyurethane chemistry and conventionally have a molecular weight of from 106 to 12,000, preferably 250 to 8,000. A broad overview of suitable reaction partners B) is to be found, for example, in N. Adam et al.: “Polyurethanes”, Ullmann's Encyclopedia of Industrial Chemistry, Electronic Release, 7th ed., chap. 3.2-3.4, Wiley-VCH, Weinheim 2005.

Suitable polyether polyols B) are, for example, those of the type mentioned in DE-A 2 622 951, column 6, line 65-column 7, line 47, or EP-A 0 978 523 page 4, line 45 to page 5, line 14, where they correspond to that stated above with respect to functionality and molecular weight. Particularly preferred polyether polyols B) are addition products of ethylene oxide and/or propylene oxide on glycerol, trimethylolpropane, ethylenediamine and/or pentaerythritol.

Suitable polyester polyols B) are, for example, those of the type mentioned in EP-A 0 978 523 page 5, lines 17 to 47 or EP-A 0 659 792 page 6, lines 8 to 19, where they correspond to that stated above, preferably those of which the hydroxyl number is from 20 to 650 mg of KOH/g.

Suitable polythiopolyols B) are, for example, the known condensation products of thiodiglycol with itself or other glycols, dicarboxylic acids, formaldehyde, aminocarboxylic acids and/or amino alcohols. Depending on the nature of the mixture components employed, these are polythio-mixed ether polyols, polythioether-ester polyols or polythioether-ester-amide polyols.

Polyacetal polyols which are suitable as component B) are, for example, the known reaction products of simple glycols, such as e.g. diethylene glycol, triethylene glycol, 4,4′-dioxethoxy-diphenyl-dimethylmethane (adduct of 2 mol of ethylene oxide on bisphenol A) or hexanediol, with formaldehyde, or also polyacetals prepared by polycondensation of cyclic acetals, such as e.g. trioxane.

Aminopolyethers or mixtures of aminopolyethers, i.e. polyethers which have groups which are reactive towards isocyanate groups and are composed of primary and/or secondary, aromatically or aliphatically bonded amino groups at least to the extent of 50 equivalent %, preferably at least to the extent of 80 equivalent %, and of primary and/or secondary aliphatically bonded hydroxyl groups as the remainder, are moreover also particularly suitable as component B). Suitable such aminopolyethers are, for example, the compounds mentioned in EP-A 0 081 701, column 4, line 26 to column 5, line 40 Amino-functional polyether-urethanes or -ureas such as can be prepared, for example, by the process of DE-A 2 948 419 by hydrolysis of isocyanate-functional polyether prepolymers, or also polyesters of the abovementioned molecular weight range containing amino groups are likewise suitable as starting component B).

Further suitable components B) which are reactive towards isocyanate groups are, for example, also the specific polyols described in EP-A 0 689 556 and EP-A 0 937 110, obtainable e.g. by reaction of epoxidized fatty acid esters with aliphatic or aromatic polyols with opening of the epoxide ring.

Polybutadienes containing hydroxyl groups can also optionally be employed as component B).

Components B) which are reactive towards isocyanate groups and are suitable for the preparation of polyurethane compositions with a very particularly high refraction of light are, in particular, also polythio compounds, for example simple alkanethiols, such as e.g. methanedithiol, 1,2-ethanedithiol, 1,1-propanedithiol, 1,2-propanedithiol, 1,3-propanedithiol, 2,2-propanedithiol, 1,4-butanedithiol, 2,3-butanedithiol, 1,5-pentanedithiol, 1,6-hexanedithiol, 1,2,3-propanetrithiol, 1,1-cyclohexanedithiol, 1,2-cyclohexanedithiol, 2,2-dimethylpropane-1,3-dithiol, 3,4-dimethoxybutane-1,2-dithiol and 2-methylcyclohexane-2,3-dithiol, polythiols containing thioether groups, such as e.g. 2,4-dimercaptomethyl-1,5-dimercapto-3-thiapentane, 4-mercaptomethyl-1,8-dimercapto-3,6-dithiaoctane, 4,8-dimercaptomethyl-1,11-dimercapto-3,6,9-trithiaundecane, 4,7-dimercaptomethyl-1,11-dimercapto-3,6,9-trithiaundecane, 5,7-dimercaptomethyl-1,11-dimercapto-3,6,9-trithiaundecane, 4,5-bis(mercaptoethylthio)-1,10-dimercapto-3,8-dithiadecane, tetrakis-(mercaptomethyl)methane, 1,1,3,3-tetrakis(mercaptomethylthio)propane, 1,1,5,5-tetrakis(mercaptomethylthio)-3-thiapentane, 1,1,6,6-tetrakis(mercaptomethylthio)-3,4-dithiahexane, 2-mercaptoethylthio-1,3-dimercaptopropane, 2,3-bis(mercaptoethylthio)-1-mercaptopropane, 2,2-bis(mercaptomethyl)-1,3-dimercaptopropane, bis(mercaptomethyl)sulfide, bis(mercaptomethyl)di-sulfide, bis(mercaptoethyl)sulfide, bis(mercaptoethyl)disulfide, bis(mercaptopropyl)sulfide, bis(mercaptopropyl)disulfide, bis(mercaptomethylthio)methane, tris(mercaptomethylthio)methane, bis(mercaptoethylthio)methane, tris(mercaptoethylthio)methane, bis(mercaptopropylthio)methane, 1,2-bis(mercaptomethylthio)ethane, 1,2-bis(mercaptoethylthio)ethane, 2-mercaptoethylthio)ethane, 1,3-bis(mercaptomethylthio)propane, 1,3-bis(mercaptopropylthio)propane, 1,2,3-tris (mercaptomethylthio)propane, 1,2,3-tris(mercaptoethylthio)propane, 1,2,3-tris(mercaptopropylthio)propane, tetrakis(mercaptomethylthio)methane, tetrakis(mercaptoethylthiomethyl)methane, tetrakis-(mercaptopropylthiomethyl)methane, 2,5-dimercapto-1,4-dithiane, 2,5-bis(mercaptomethyl)-1,4-dithiane and oligomers thereof obtainable according to JP-A 07118263, 1,5-bis(mercaptopropyl)-1,4-dithiane, 1,5-bis(2-mercaptoethylthiomethyl)-1,4-dithiane, 2-mercaptomethyl-6-mercapto-1,4-dithiacycloheptane, 2,4,6-trimercapto-1,3,5-trithiane, 2,4,6-trimercaptomethyl-1,3,5-trithiane and 2-(3-bis(mercaptomethyl)-2-thiapropyl)-1,3-dithiolane, polyester thiols, such as e.g. ethylene glycol bis(2-mercaptoacetate), ethylene glycol bis(3-mercaptopropionate), diethylene glycol(2-mercaptoacetate), diethylene glycol(3-mercaptopropionate), 2,3-dimercapto-1-propanol(3-mercaptopropionate), 3-mercapto-1,2-propanediol bis(2-mercaptoacetate), 3-mercapto-1,2-propanediol bis(3-mercaptopropionate), trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), glycerol tris(2-mercaptoacetate), glycerol tris(3-mercaptopropionate), 1,4-cyclohexanediol bis(2-mercaptoacetate), 1,4-cyclohexanediol bis(3-mercaptopropionate), hydroxymethyl-sulfide bis(2-mercaptoacetate), hydroxymethyl-sulfide bis(3-mercaptopropionate), hydroxyethyl-sulfide(2-mercaptoacetate), hydroxyethyl-sulfide(3-mercaptopropionate), hydroxymethyl-disulfide(2-mercaptoacetate), hydroxymethyl-disulfide(3-mercaptopropionate), (2-mercaptoethyl ester)thioglycollate and bis(2-mercaptoethyl ester)thiodipropionate, as well as aromatic thio compounds, such as e.g. 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercaptoethyl)benzene, 1,2,4-tris(mercaptoethyl)benzene, 2,5-toluenedithiol, 3,4-toluenedithiol, 1,4-naphthalenedithiol, 1,5-naphthalenedithiol, 2,6-naphthalenedithiol, 2,7-naphthalenedithiol, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)-benzene, 1,2,3,4-tetrakis(mercaptoethyl)benzene, 1,2,3,5-tetrakis(mercaptoethyl)benzene, 1,2,4,5-tetrakis(mercaptoethyl)benzene, 2,2′-dimercaptobiphenyl and 4,4′-dimercaptobiphenyl.

Preferred polythio compounds B) are polythioether and polyester thiols of the type mentioned. Particularly preferred polythio compounds B) are 4-mercaptomethyl-1,8-dimercapto-3,6-dithiaoctane, 2,5-bismercaptomethyl-1,4-dithiane, 1,1,3,3-tetrakis(mercaptomethylthio)propane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, trimethylolpropane tris(3-mercaptopropionate), trimethylolethane tris(2-mercaptoacetate), pentaerythritol tetrakis(2-mercaptoacetate) and pentaerythritol tetrakis(3-mercaptopropionate).

Sulfur-containing hydroxy compounds are moreover also suitable as components B) which are reactive towards isocyanate groups. There may be mentioned here by way of example simple mercapto-alcohols, such as e.g. 2-mercaptoethanol, 3-mercaptopropanol, 1,3-dimercapto-2-propanol, 2,3-dimercaptopropanol and dithioerythritol, alcohols containing thioether structures, such as e.g. di(2-hydroxyethyl)sulfide, 1,2-bis(2-hydroxyethylmercapto)ethane, bis(2-hydroxyethyl)disulfide and 1,4-dithiane-2,5-diol, or sulphur-containing diols with a polyester-urethane, polythioester-urethane, polyester-thiourethane or polythioester-thiourethane structure, of the type mention in EP-A 1 640 394.

Low molecular weight, hydroxy- and/or amino-functional components, i.e. those having a molecular weight range of from 60 to 500, preferably from 62 to 400, can also be employed in the preparation of the light-fast polyurethane compositions according to the invention as compounds B) which are reactive towards isocyanates.

These are, for example, simple mono- or polyfunctional alcohols having 2 to 14, preferably 4 to 10 carbon atoms, such as e.g. 1,2-ethanediol, 1,2- and 1,3-propanediol, the isomeric butanediols, pentanediols, hexanediols, heptanediols and octanediols, 1,10-decanediol, 1,2- and 1,4-cyclohexanediol, 1,4-cyclohexanedimethanol, 4,4′-(1-methylethylidene)-biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol, bis-(2-hydroxyethyl)-hydroquinone, 1,2,4- and 1,3,5-trihydroxycyclohexane or 1,3,5-tris(2-hydroxyethyl)isocyanurate.

Examples of suitable low molecular weight amino-functional compounds are, for example, aliphatic and cycloaliphatic amines and amino alcohols with amino groups bonded as primary and/or secondary groups, such as e.g. cyclohexylamine, 2-methyl-1,5-pentanediamine, diethanolamine, monoethanolamine, propylamine, butylamine, dibutylamine, hexylamine, monoisopropanolamine, diisopropanolamine, ethylenediamine, 1,3-diaminopropane, 1,4-diaminobutane, isophoronediamine, diethylenetriamine, ethanolamine, aminoethylethanolamine, diaminecyclohexane, hexamethylenediamine, methyliminobispropylamine, iminobispropylamine, bis(aminopropyl)piperazine, aminoethylpiperazine, 1,2-diaminocyclohexane, triethylenetetramine, tetraethylenepentamine, 1,8-p-diaminomenthane, bis(4-aminocyclohexyl)methane, bis(4-amino-3-methylcyclohexyl)methane, bis(4-amino-3,5-dimethylcyclohexyl)methane, bis(4-amino-2,3,5-trimethylcyclohexyl)methane, 1,1-bis(4-aminocyclohexyl)propane, 2,2-bis(4-aminocyclohexyl)propane, 1,1-bis(4-aminocyclohexyl)ethane, 1,1-bis(4-aminocyclohexyl)butane, 2,2-bis(4-aminocyclohexyl)butane, 1,1-bis(4-amino-3-methylcyclohexyl)ethane, 2,2-bis(4-amino-3-methylcyclohexyl)propane, 1,1-bis(4-amino-3,5-dimethylcyclohexyl)ethane, 2,2-bis(4-amino-3,5-dimethylcyclohexyl)propane, 2,2-bis(4-amino-3,5-dimethylcyclohexyl)butane, 2,4-diaminodicyclohexylmethane, 4-aminocyclohexyl-4-amino-3-methylcyclohexylmethane, 4-amino-3,5-dimethylcyclohexyl-4-amino-3-methylcyclohexylmethane and 2-(4-aminocyclohexyl)-2-(4-amino-3-methylcyclohexyl)methane.

Examples of aromatic polyamines, in particular diamines, with molecular weights below 500 which are suitable compounds B) which are reactive towards isocyanates are e.g. 1,2- and 1,4-diaminobenzene, 2,4- and 2,6-diaminotoluene, 2,4′- and/or 4,4′-diaminodiphenylmethane, 1,5-diaminonaphthalene, 4,4′,4″-triaminotriphenylmethane, 4,4′-bis-(methylamino)-diphenylmethane or 1-methyl-2-methylamino-4-aminobenzene, 1-methyl-3,5-diethyl-2,4-diaminobenzene, 1-methyl-3,5-diethyl-2,6-diaminobenzene, 1,3,5-trimethyl-2,4-diaminobenzene, 1,3,5-triethyl-2,4-diaminobenzene, 3,5,3′,5′-tetraethyl-4,4′-diaminodiphenylmethane, 3,5,3′,5′-tetraisopropyl-4,4′-diaminodiphenylmethane, 3,5-diethyl-3′,5′-diisopropyl-4,4′-diaminodiphenylmethane, 3,3′-diethyl-5,5′-diisopropyl-4,4′-diaminodiphenylmethane, 1-methyl-2,6-diamino-3-isopropylbenzene, liquid mixtures of polyphenylpolymethylenepolyamines, such as are obtainable in a known manner by condensation of aniline with formaldehyde, and any desired mixtures of such polyamines. In this connection, for example, mixtures of 1-methyl-3,5-diethyl-2,4-diaminobenzene with 1-methyl-3,5-diethyl-2,6-diaminobenzene in a weight ratio of from 50:50 to 85:15, preferably from 65:35 to 80:20 may be mentioned in particular.

The use of low molecular weight amino-functional polyethers with molecular weights below 500 is likewise possible. These are, for example, those with primary and/or secondary, aromatically or aliphatically bonded amino groups, the amino groups of which are optionally bonded to the polyether chains via urethane or ester groups and which are accessible by known processes already described above for the preparation of the higher molecular weight aminopolyethers.

Sterically hindered aliphatic diamines with two amino groups bonded as secondary groups can optionally also be employed as components B) which are reactive towards isocyanate groups, such as e.g. the reaction products, known from EP-A 0 403 921, of aliphatic and/or cycloaliphatic diamines with maleic acid esters or fumaric acid esters, the bis-adduct, obtainable according to the teaching of EP-A 1 767 559, of acrylonitrile on isophoronediamine, or the hydrogenation products, described for example in DE-A 19 701 835, of Schiff s bases accessible from aliphatic and/or cycloaliphatic diamines and ketones, such as e.g. diisopropyl ketone.

Preferred reaction partners B) for the polyisocyanate mixtures A) are the abovementioned polymeric polyether polyols, polyester polyols and/or aminopolyethers, the polythio compounds mentioned, low molecular weight aliphatic and cycloaliphatic polyfunctional alcohols and the low molecular weight polyfunctional amines mentioned, in particular sterically hindered aliphatic diamines with two amino groups bonded as secondary groups.

Any desired mixtures of the reactive components B) which are reactive towards isocyanate groups and are mentioned above by way of example are also suitable as reaction partners for the polyisocyanate mixtures A). While pure polyurethane compositions are obtained using exclusively hydroxy-functional components B), pure polythiourethanes are obtained with the exclusive use of thio compounds B) and polyurea compositions are obtained with the exclusive use of polyamines B), by using amino alcohols, mercapto-alcohols or suitable mixtures of hydroxy-, mercapto- and amino-functional compounds as component B), polyaddition compounds in which the equivalent ratio of urethane to thiourethane and/or urea groups can be adjusted as desired can be prepared.

The polyisocyanate components A) are as a rule employed as the sole polyisocyanate component in the preparation of light-fast polyurethane compositions. However, it is also possible in principle to employ the polyisocyanate components A) in a mixture with any desired further solvent-free aliphatic and/or cycloaliphatic di- and/or polyisocyanates, such as e.g. hexamethylene-diisocyanate (HDI), 1-isocyanato-3,3,5-trimethyl-5-isocyanatomethylcyclohexane (isophorone-diisocyanate, IPDI), 1,3-diisocyanato-2(4)-methylcyclohexane, 4,4′- and/or 4,2′-diisocyanatodicyclohexylmethane, the known lacquer polyisocyanates with a uretdione, isocyanurate, allophanate, biuret, iminooxadiazinedione and/or oxadiazinetrione structure based on these diisocyanates, such as are described by way of example, for example, in J. Prakt. Chem. 336 (1994) 185-200 and EP-A 0 798 299, the solutions, known from EP-A 0 693 512 and EP-A 1 484 350, of cycloaliphatic polyisocyanates in low-viscosity HDI polyisocyanates, the solvent-free polyisocyanates, described in EP-A 0 047 452 and EP-B 0 478 990, obtainable from mixtures of HDI and isophorone-diisocyanate (IPDI) by dimerization and/or trimerization, or also polyester-modified HDI polyisocyanates of the type known from EP-A 0 336 205.

Regardless of the nature of the starting substances chosen, in the process according to the invention the reaction of the polyisocyanate mixtures A) with the components B) which are reactive towards isocyanate groups is carried out maintaining an equivalent ratio of isocyanate groups to groups which are reactive towards isocyanates of from 0.5:1 to 2.0:1, preferably from 0.7:1 to 1.3:1, particularly preferably from 0.8:1 to 1.2:1.

In addition to the starting components A) and B) mentioned, further auxiliary substances and additives C) can optionally be co-used in this context, such as e.g. catalysts, blowing agents, surface-active agents, UV stabilizers, foam stabilizers, antioxidants, mould release agents, fillers and pigments.

Conventional catalysts known from polyurethane chemistry, for example, can be employed to accelerate the reaction. There may be mentioned here by way of example tertiary amines, such as e.g. triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis-(dimethylaminopropyl)-urea, N-methyl- and N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,8-diazabicyclo(5.4.0)undec-7-ene (DBU), 1,2-dimethylimidazole, 2-methylimidazole, N,N-dimethylimidazole-β-phenylethylamine, 1,4-diazabicyclo-(2,2,2)-octane, bis-(N,N-dimethylaminoethyl)adipate; alkanolamine compounds. such as e.g. triethanolamine, triisopropanolamine, N-methyl- and N-ethyl-diethanolamine, dimethylaminoethanol, 2-(N,N-dimethylaminoethoxy)ethanol, N,N′,N″-tris-(dialkylaminoalkyl)hexahydrotriazines, e.g. N,N′,N″-tris-(dimethylaminopropyl)-s-hexahydrotriazine and/or bis(dimethylaminoethyl)ether; metal salts, such as e.g. inorganic and/or organic compounds of iron, lead, bismuth, zinc and/or tin in conventional oxidation levels of the metal, for example iron(II) chloride, iron(III) chloride, bismuth(III) 2-ethylhexanoate, bismuth(III) octoate, bismuth(III) neodecanoate, zinc chloride, zinc 2-ethylcaproate, tin(II) octoate, tin(II) ethylcaproate, tin(II) palmitate, dibutyltin(IV) dilaurate (DBTL), dibutyltin(IV) dichloride or lead octoate; amidines, such as e.g. 2,3-dimethyl-3,4,5,6-tetrahydropyrimidine; tetraalkylammonium hydroxides, such as e.g. tetramethylammonium hydroxide; alkali metal hydroxides, such as e.g. sodium hydroxide, and alkali metal alcoholates, such as e.g. sodium methylate and potassium isopropylate, and alkali metal salts of long-chain fatty acids having 10 to 20 C atoms and optionally side-chain OH groups.

Preferred catalysts C) to be employed are tertiary amines and bismuth and tin compounds of the type mentioned.

The catalysts mentioned by way of example can be employed individually or in the form of any desired mixtures with one another in the preparation of the light-fast polyurethane, polythiourethane and/or polyurea compositions according to the invention, and are optionally employed in this context in amounts of from 0.01 to 5.0 wt. %, preferably 0.1 to 2 wt. %, calculated as the total amount of catalysts employed, based on the total amount of starting compounds used.

Transparent compact mouldings with a high refractive index are preferably produced by the process according to the invention. By addition of suitable blowing agents, however, foamed shaped articles can also be obtained if desired. Blowing agents which are suitable for this are, for example, readily volatile organic substances, such as e.g. acetone, ethyl acetate, halogen-substituted alkanes, such as methylene chloride, chloroform, ethylidene chloride, vinylidene chloride, monofluorotrichloromethane, chlorotrifluoromethane or dichlorodifluoromethane, butane, hexane, heptane or diethyl ether and/or dissolved inert gases, such as e.g. nitrogen, air or carbon dioxide.

Possible chemical blowing agents C), i.e. blowing agents which form gaseous products due to a reaction, for example with isocyanate groups, are, for example, water, compounds containing water of hydration, carboxylic acids, tertiary alcohols, e.g. t-butanol, carbamates, for example the carbamates described in EP-A 1 000 955, in particular on page 2, lines 5 to 31 and page 3, lines 21 to 42, carbonates, e.g. ammonium carbonate and/or ammonium bicarbonate and/or guanidine carbamate.

A blowing action can also be achieved by addition of compounds which decompose at temperatures above room temperature with splitting off of gases, for example nitrogen, e.g. azo compounds, such as azodicarboxamide or azoisobutyric acid nitrile. Further examples of blowing agents and details of the use of blowing agents are described in Kunststoff-Handbuch, volume VII, published by Vieweg and Hochtlen, Carl-Hanser-Verlag, Munich 1966, e.g. on pages 108 and 109, 453 to 455 and 507 to 510.

According to the invention, surface-active additives C) can also be co-used as emulsifiers and foam stabilizers. Suitable emulsifiers are, for example, the sodium salts of castor oil sulfonates or fatty acids, and salts of fatty acids with amines, such as e.g. diethylamine oleate or diethanolamine stearate. Alkali metal or ammonium salts of sulfonic acids, such as e.g. of dodecylbenzenesulfonic acids, fatty acids, such as ricinoleic acid, or polymeric fatty acids, or ethoxylated nonylphenol can also be co-used as surface-active additives.

Suitable foam stabilizers are, in particular, the known, preferably water-soluble polyether siloxanes such as are described, for example, in U.S. Pat. No. 2,834,748, DE-A 1 012 602 and DE-A 1 719 238. The polysiloxane/polyoxyalkylene copolymers branched via allophanate groups, obtainable according to DE-A 2 558 523, are also suitable foam stabilizers.

The abovementioned emulsifiers and stabilizers optionally to be co-used in the process according to the invention can be employed both individually and in any desired combinations with one another.

The bodies obtained from the polyurethane compositions which can be prepared and used according to the invention are already distinguished as such, i.e. without the addition of corresponding stabilizers, by a very good stability to light. Nevertheless, UV protection agents (light stabilizers) or antioxidants of the known type can optionally be co-used as further auxiliary substances and additives C) in their production.

Suitable UV stabilizers C) are, for example, piperidine derivatives, such as e.g. 4-benzoyloxy-2,2,6,6-tetramethylpiperidine, 4-benzoyloxy-1,2,2,6,6-pentamethylpiperidine, bis-(2,2,6,6-tetramethyl-4-piperidyl)sebacate, bis(1,2,2,6,6-pentamethyl-4-piperidyl)sebacate, methyl(1,2,2,6,6-pentamethyl-4-piperidyl)sebacate, bis-(2,2,6,6-tetramethyl-4-piperidyl)suberate or bis-(2,2,6,6-tetramethyl-4-piperidyl)dodecanedioate, benzophenone derivatives, such as e.g. 2,4-dihydroxy-, 2-hydroxy-4-methoxy-, 2-hydroxy-4-octoxy-, 2-hydroxy-4-dodecyloxy- or 2,2′-dihydroxy-4-dodecyloxy-benzophenone, benzotriazole derivatives, such as e.g. 2-(5-methyl-2-hydroxyphenyl)benzotriazole, 2-(5-tert-butyl-2-hydroxyphenyl)benzotriazole, 2-(5-tert-octyl-2-hydroxyphenyl)benzotriazole, 2-(5-dodecyl-2-hydroxyphenyl)benzotriazole, 2-(3,5-di-tert-butyl-2-hydroxyphenyl)-5-chlorobenzotriazole, 2-(3,5-di-tert-amyl-2-hydroxyphenyl)benzotriazole, 2-(3,5-di-tert-butyl-2-hydroxyphenyl)benzotriazole, 2-(3-tert-butyl-5-methyl-2-hydroxyphenyl)-5-chlorobenzotriazole and esterification products of 2-(3-tert-butyl-5-propionic acid-2-hydroxyphenyl)benzotriazole with polyethylene glycol 300, oxalanilides, such as e.g. 2-ethyl-2′-ethoxy- or 4-methyl-4′-methoxyoxalanilide, salicylic acid esters, such as e.g. salicylic acid phenyl ester, salicylic acid 4-tert-butylphenyl ester and salicylic acid 4-tert-octylphenyl ester, cinnamic acid derivatives, such as e.g. α-cyano-β-methyl-4-methoxycinnamic acid methyl ester, α-cyano-β-methyl-4-methoxycinnamic acid butyl ester, α-cyano-β-phenylcinnamic acid ethyl ester and α-cyano-β-phenylcinnamic acid isooctyl ester, or malonic ester derivatives, such as e.g. 4-methoxy-benzylidenemalonic acid dimethyl ester, 4-methoxybenzylidenemalonic acid diethyl ester and 4-butoxy-benzylidenemalonic acid dimethyl ester. These light stabilizers can be employed both individually and in any desired combinations with one another.

Suitable antioxidants C) are, for example, the known sterically hindered phenols, such as e.g. 2,6-di-tert-butyl-4-methylphenol(ionol), pentaerythritol tetrakis(3-(3,5-di-tert-butyl-4-hydroxyphenyl)propionate), octadecyl 3-(3,5-di-tert-butyl-4-hydroxyphenyl)-propionate, triethylene glycol bis(3-tert-butyl-4-hydroxy-5-methylphenyl)propionate, 2,2′-thio-bis(4-methyl-6-tert-butylphenol), 2,2′-thiodiethyl bis[3-(3,5-di-tert-butyl-4-hydroxyphenyl)propionate), which are employed both individually and in any desired combinations with one another.

Further auxiliary substances and additives C) which are optionally to be co-used are, for example, cell regulators of the type known per se, such as e.g. paraffins or fatty alcohols, the known flameproofing agents, such as e.g. tris-chloroethyl phosphate, ammonium phosphate or polyphosphate, fillers, such as e.g. barium sulfate, kieselguhr, carbon black, prepared chalk or also reinforcing glass fibres. Finally, the internal mould release agents, dyestuffs, pigments, hydrolysis stabilizers and fungistatically and bacteriostatically acting substances known per se can optionally also be co-used in the process according to the invention.

The auxiliary substances and additives C) mentioned which are optionally to be co-used can be admixed both to the polyisocyanate component A) and/or to the component B) which is reactive towards isocyanate groups.

For the production of the light-fast bodies according to the invention from polyurethane compositions, the low-monomer polyisocyanates A) are mixed, with the aid of suitable mixing units, with the component B) which is reactive towards isocyanate groups, optionally co-using the abovementioned auxiliary substances and additives C), in a solvent-free form in the abovementioned equivalent ratio of isocyanate groups to groups which are reactive towards isocyanates, and the mixture is cured by any desired methods in open or closed moulds, for example by simple manual pouring, but preferably with the aid of suitable machines, such as e.g. the conventional low pressure or high pressure machines in polyurethane technology, or by the RIM process, in a temperature range of from 40 to 180° C., preferably from 50 to 140° C., particularly preferably from 60 to 120° C., and optionally under an increased pressure of up to 300 bar, preferably up to 100 bar, particularly preferably up to 40 bar.

In this procedure, the polyisocyanates A) and optionally also the starting components B) are preheated to a temperature of at least 40° C., preferably at least 50° C., particularly preferably at least 60° C. to reduce the viscosities, and optionally degassed by application of a vacuum.

As a rule, the bodies produced in this way from the polyurethane compositions which are prepared and can be used according to the invention can be removed from the mould after a short time, for example after a time of from 2 to 60 min. If appropriate, a post-curing at a temperature of from 50 to 100° C., preferably at 60 to 90° C., can follow.

Compact or foamed, light- and weather-resistant polyurethane bodies which have a high resistance to solvents and chemicals and outstanding mechanical properties, in particular an excellent heat distortion point also at higher temperatures of, for example, 90° C., are obtained in this manner. Compared with the polyurethanes known to date which have been prepared using exclusively monomeric araliphatic diisocyanates, the polyurethane compositions according to the invention cure with significantly less volume shrinkage.

Preferably, the low-monomer araliphatic polyisocyanates A) are used for the production of transparent shaped articles which show a higher refraction of light compared with the polyurethanes of the prior art which are based exclusively on monomeric araliphatic diisocyanates. These transparent polyurethane bodies are suitable for a large number of different uses, for example for the production of or as glass substitute panes, such as e.g. sunroofs, front, rear or side screens in vehicle or aircraft construction, and as safety glass.

The polyurethane compositions according to the invention are moreover also outstandingly suitable for transparent embedding of optical, electronic or optoelectronic components, such as e.g. of solar modules, light-emitting diodes or of lenses or collimators, such as are employed, for example, as a supplementary lens in LED lamps or automobile headlamps.

A particularly preferred field of use for the polyurethane compositions according to the invention obtainable from the low-monomer araliphatic polyisocyanates A) is, however, the production of lightweight spectacle lenses of plastic which have a high refractive index and high Abbe number. Spectacle lenses produced according to the invention are distinguished by outstanding mechanical properties, in particular hardness and impact strength as well as good scratch resistance, and moreover are easy to work and can be coloured as desired.

### EXAMPLES

Unless noted otherwise, all the percentage data relate to the weight.

The NCO contents were determined titrimetrically in accordance with DIN EN ISO 11909.

OH numbers were determined titrimetrically in accordance with the method of DIN 53240 Part 2, and acid numbers in accordance with DIN 3682.

The monomer contents were measured by gas chromatography with an internal standard in accordance with DIN EN ISO 10283.

All the viscosity measurements were made with a Physica MCR 51 rheometer from Anton Paar Germany GmbH (DE) in accordance with DIN EN ISO 3219.

The glass transition temperature Tg was determined by means of DSC (differential scanning calorimetry) using a Mettler DSC 12E (Mettler Toledo GmbH, Giessen, DE) at a heating up rate of 20° C./min.

Shore hardnesses were measured in accordance with DIN 53505 with the aid of a Zwick 3100 Shore hardness test apparatus (Zwick, DE).

The refractive indices and Abbe numbers were measured on an Abbe refractometer, model B from Zeiss.

Starting Compounds

Polyisocyanate A1)

60.0 g (3.3 mol) of water were metered continuously into a mixture of 2,820 g (15 mol) of 1,3-bis(isocyanatomethyl)benzene (m-XDI) and 1.15 g (0.55 mol) of dibutyl phosphate at a temperature of 80° C. over a period of 5 hours, under nitrogen and while stirring. A short time after the start of the addition of water, a constant evolution of CO₂ started, which had ended after an after-stirring time of 3 hours at 90° C. A colourless solution of an m-XDI biuret polyisocyanate (40.8 wt. %) in excess monomeric diisocyanate (59.2 wt. %) was present.

NCO content: 30.0%

Viscosity (23° C.): 340 mPas

Refractive index n_{D}²⁰: 1.5737

Density (23° C.): 1.236 g/cm⁻³

Polyisocyanate A2)

70 g (0.77 mol) of 1,3-butanediol were added in portions to 940 g (5.0 mol) of m-XDI at 70° C. in the course of one hour, under nitrogen and while stirring, and when the addition had ended the mixture was stirred for a further hour. The reaction mixture was then heated up to 95° C. and the allophanation reaction was started by addition of 0.3 g of zinc(II) 2-ethyl-1-hexanoate. After a reaction time of 10 hours at 95° C., the NCO content had fallen to 28.5% and the catalyst was deactivated by addition of 0.25 g of ortho-phosphoric acid (85%) and stirring at 90° C. for two hours. A colourless solution of an m-XDI allophanate polyisocyanate (40.2 wt. %) in excess monomeric diisocyanate (59.8 wt. %) was present.

NCO content: 27.9%

Viscosity (23° C.): 520 mPas

Refractive index n_{D}²⁰: 1.5625

Density (23° C.): 1.220 g/cm⁻³

Polyisocyanate A3)

9.4 g (0.09 mol) of benzyl alcohol were added to 940 g (5.0 mol) of m-XDI at 70° C., under nitrogen and while stirring, and the mixture was then heated up to 110° C. 2.2 g of a 50% strength solution of zinc(II) 2-ethyl-1-hexanoate in 2-ethyl-1-hexanol were added continuously, as a trimerization catalyst, over a period of 4 hours. The reaction mixture was stirred at 110° C. for a further two hours and then cooled to 90° C. and the trimerization reaction was stopped by addition of 0.4 g of ortho-phosphoric acid (85%) and after-stirring for two hours. A colourless solution of an m-XDI polyisocyanate containing isocyanurate groups (41.4 wt. %) in excess monomeric diisocyanate (58.6 wt. %) was present.

NCO content: 30.0%

Viscosity (23° C.): 670 mPas

Refractive index n_{D}²⁰: 1.5765

Density (23° C.): 1.242 g/cm⁻³

Polyisocyanate A4)

940 g (5.0 mol) of m-XDI were initially introduced into a stirred apparatus at 60° C. under dry nitrogen. 2.5 g of a 50% strength solution of tetrabutylphosphonium hydrogen difluoride in isopropanol/methanol (2:1) were added in portions, as a catalyst, in the course of 20 minutes such that the internal temperature did not exceed 70° C. After an NCO content of 35.0% was reached, the reaction was stopped by addition of 0.75 g of dibutyl phosphate and after-stirring at 70° C. for one hour. A colourless solution of an m-XDI polyisocyanate containing isocyanurate and iminooxadiazinedione groups (46.6 wt. %) in excess monomeric diisocyanate (53.4 wt. %) was present.

NCO content: 34.4%

Viscosity (23° C.): 50 mPas

Refractive index n_{D}²⁰: 1.5651

Density (23° C.): 1.236 g/cm⁻³

Hydroxy-functional reaction partner B1)

Solvent-free polyester polyol, prepared as described in WO 2010/083958 under starting compounds as the hydroxy-functional reaction partner B1).

| | |
|---|---|
| Viscosity (23° C.): | 19,900 mPas |
| OH number: | 628 mg of KOH/g |
| Acid number: | 2.2 mg of KOH/g |
| OH functionality: | 2.6 |
| Average molecular weight: | 243 g/mol (calculated from the OH number) |

Mercapto-Functional Reaction Partner B2)

Pentaerythritol tetrakis(3-mercaptopropionate) (=THIOCURE® PETMP, Bruno Bock, DE)

Equivalent weight: 122.2 g/eq of SH

Compared with the polyurethanes known to date which have been prepared using exclusively monomeric araliphatic diisocyanates, the polyurethane compositions according to the invention cure without or with very little volume shrinkage.

### Examples 1 to 10

### Preparation of Polyurethane Embedding Compositions

For the preparation of embedding compositions, the polyisocyanate mixtures A) and the polyol components B) were preheated to 50° C. in the combinations and ratios of amounts (parts by wt.) stated in Table 1, in each case corresponding to an equivalent ratio of isocyanate groups to groups which are reactive towards isocyanate groups of 1:1, and the mixture was homogenized with the aid of a SpeedMixer DAC 150 FVZ (Hauschild, DE) for 1 min at 3,500 rpm and then poured manually into open polypropylene moulds which were not heated. For comparison, corresponding embedding compositions were prepared in an analogous manner using monomeric m-XDI as the polyisocyanate component. After curing at 70° C. in a drying cabinet for 24 hours, the test specimens (diameter 50 mm, height 5 mm) were removed from the mould.

After a post-curing time of a further 24 hours at room temperature, the test specimens were tested for their mechanical and optical properties. The test results are likewise to be found in the following Table 1.

TABLE 1

| | Example | | | | | | | | | |
|---|---|---|---|---|---|---|---|---|---|---|
| | 1 | | | | | 6 | | | | |
| | (comparison) | 2 | 3 | 4 | 5 | (comparison) | 7 | 8 | 9 | 10 |
| m-XDI | 27.9 | — | — | — | — | 43.5 | — | — | — | — |
| Polyisocyanate | — | 36.1 | — | — | — | — | 52.9 | — | — | — |
| mixture A1) | | | | | | | | | | |
| Polyisocyanate | — | — | 38.3 | — | — | — | — | 55.3 | — | — |
| mixture A2) | | | | | | | | | | |
| Polyisocyanate | — | — | — | 36.6 | — | — | — | — | 53.4 | — |
| mixture A3) | | | | | | | | | | |
| Polyisocyanate | — | — | — | — | 33.4 | — | — | — | — | 50.0 |
| mixture A4) | | | | | | | | | | |
| Reaction partner | 72.1 | 63.9 | 61.7 | 63.4 | 66.6 | — | — | — | — | — |
| B1) | | | | | | | | | | |
| Reaction partner | — | — | — | — | — | 56.5 | 47.1 | 44.7 | 46.7 | 50.0 |
| B2) | | | | | | | | | | |
| Appearance | clear | clear | clear | clear | clear | clear | clear | clear | clear | clear |
| Tg [° C.] | 76 | 97 | 92 | 100 | 91 | 85 | 103 | 102 | 109 | 101 |
| Shore D hardness | 81 | 85 | 86 | 86 | 89 | 78 | 87 | 85 | 83 | 89 |
| Density [g/cm³] | 1.255 | 1.245 | 1.238 | 1.251 | 1.247 | 1.370 | 1.339 | 1.315 | 1.344 | 1.340 |
| Volume shrinkage | 9.2 | 6.8 | 6.5 | 7.0 | 7.3 | 9.9 | 6.5 | 5.4 | 6.6 | 6.5 |
| [%] | | | | | | | | | | |
| Refractive index | 1.5551 | 1.5669 | 1.5613 | 1.5600 | 1.5626 | 1.5927 | 1.5969 | 1.5899 | 1.5964 | 1.5967 |
| n_{D}²⁰ | | | | | | | | | | |
| Abbe number | 41 | 36 | 37 | 44 | 41 | 34 | 37 | 37 | 36 | 37 |

The comparison shows that the embedding compositions prepared according to the invention (Examples 2 to 5 and 7 to 10) cure with significantly less volume shrinkage than the compositions prepared using exclusively monomeric m-XDI as the polyisocyanate component (Comparison Examples 1 and 6) and thereby at the same time lead to higher refractive indices and higher hardnesses and glass transition temperatures.

1. Method of producing light-last compact or foamed polyurethane bodies using solvent-free polyisocyanate components A) which comprise, to the extent of 5 to 95 wt. %, polyisocyanate molecules built up from at least two araliphatic diisocyanate molecules and, to the extent of 95 to 5 wt. %, monomeric araliphatic diisocyanates and have a content of isocyanate groups of from 18 to 43 wt. %.

2. Method according to claim 1, wherein the polyisocyanate components A) have uretdione, isocyanurate, iminooxadiazinedione, allophanate and/or biuret structures.

3. Method according to claim 1, wherein the polyisocyanate components A) are polyisocyanates based on 1,3-bis(isocyanatomethyl)benzene, 1,4-bis(isocyanatomethyl)benzene and/or 1,3-bis(2-isocyanatopropan-2-yl)benzene with a content of isocyanate groups of from 24 to 35 wt. %.

4. Method according to claim 1, which produces compact transparent polyurethane bodies.

5. Method according to claim 4, wherein the polyurethane bodies are glass substitute parts.

6. Method according to claim 4, wherein the polyurethane bodies are optical, optoelectronic or electronic components.

7. Method according to claim 6, wherein the components are optical lenses or spectacle lenses.

8. Method according to claim 6, wherein the components are light-emitting diodes.

9. Process for the preparation of light-fast polyurethane compositions solvent-free reacting of
A) polyisocyanate mixtures which comprise, to the extent of 5 to 95 wt. %, polyisocyanates built up from at least two araliphatic diisocyanate molecules and, to the extent of 95 to 5 wt. %, monomeric araliphatic diisocyanates and have a content of isocyanate groups of from 18 to 43 wt. %,
with
B) reaction partners which are reactive towards isocyanate groups and have an average functionality of from 2.0 to 6.0, and optionally co-using
C) further auxiliary substances and additives,
maintaining an equivalent ratio of isocyanate groups to groups which are reactive towards isocyanates of from 0.5:1 to 2.0:1.

10. Process according to claim 9, wherein hydroxy-, amino- and/or mercapto-functional compounds having an average molecular weight of from 60 to 12,000 are employed as component B).

11. Process according to claim 9, wherein polyether polyols, polyester polyols, polycarbonate polyols and/or aminopolyethers having an average molecular weight of from 106 to 12,000, polythioether thiols, polyester thiols, sulfur-containing hydroxy compounds and/or low molecular weight hydroxy- and/or amino-functional components having an average molecular weight of from 60 to 500 are employed as component B).

12. Process according to claim 9, wherein catalysts, UV stabilizers, antioxidants and/or mould release agents are employed as component C.

13. Process according to claim 9, wherein the reaction of the reaction partners is carried out at a temperature of up to 180° C. under a pressure of up to 300 bar.
